(19) United States
(12) Patent Application Publication
(10) Pub. No.: US 2013/0038550 A1
(43) Pub. Date: Feb. 14, 2013

(54) MULTI-PROTECTION TOUCH LOCK

(71) Applicants: Ta-Yi Chien, Taipei City (TW); Hai-Yin Hsu, Taipei City (TW); Kuan-Yu Chen, Taipei (TW); Fen-Ling Hu, Taipei City (TW); Wei-Yu Lee, Taipei City (TW); Kun-Yi Lee, Taipei City (TW); Yen-Juei Lin, Taipei City (TW); Chien-Chun Chen, Taipei City (TW); Chain-Shiun Kao, Taipei City (TW); Min-Han Lin, Taipei City (TW); Chia-Yu Guo, Taipei City (TW); Chun-Han Chou, Taipei City (TW); Shih-Han Zeng, Taipei City (TW); Shang-Ching Lin, Taipei City (TW)

(72) Inventors: Ta-Yi Chien, Taipei City (TW); Hai-Yin Hsu, Taipei City (TW); Kuan-Yu Chen, Taipei (TW); Fen-Ling Hu, Taipei City (TW); Wei-Yu Lee, Taipei City (TW); Kun-Yi Lee, Taipei City (TW); Yen-Juei Lin, Taipei City (TW); Chien-Chun Chen, Taipei City (TW); Chain-Shiun Kao, Taipei City (TW); Min-Han Lin, Taipei City (TW); Chia-Yu Guo, Taipei City (TW); Chun-Han Chou, Taipei City (TW); Shih-Han Zeng, Taipei City (TW); Shang-Ching Lin, Taipei City (TW)

(73) Assignee: LATTICE ENERGY TECHNOLOGY CORPORATION, Taipei City (TW)

(21) Appl. No.: 13/567,486

(22) Filed: Aug. 6, 2012

Related U.S. Application Data
(60) Provisional application No. 61/521,001, filed on Aug. 8, 2011.

(51) Int. Cl. E05B 47/00; G06F 3/041; E05B 49/00

(52) U.S. Cl. 345/173; 70/319; 70/276; 70/278.1

(57) ABSTRACT

A multi-protection touch lock has a lock body and an unlocking panel connecting to the lock body. The lock body has a control mechanism, a locking unit connecting to the control mechanism, and at least one displaying unit connecting to the control unit, and at least one connection interface connecting to the displaying unit. The at least one unlocking panel has at least one transmission interface connecting to the at least one connection interface, and at least one operating unit connecting to the at least one transmission interface. The lock can be located at the predetermined position to control the door access, vehicle actuation and the use of electrical appliances. When unlocking, the unlocking panel comes to in contact with the lock and the correct password is input via the unlocking panel. After the unlocking action is completed, the unlocking panel is removed from the predetermined position.

### BACKGROUND OF THE INVENTION

1. Field of the Invention

The present invention relates to a multi-protection touch panel, and particularly to a multi-protection touch panel in which the lock can be located at the predetermined position to control the door access, vehicle actuation and the use of electrical appliances. When unlocking, the unlocking panel comes to in contact with the lock and the correct password is input via the unlocking panel. After the unlocking action is completed, the unlocking panel is removed from the predetermined position. Thereby the improved antitheft effect is achieved.

2. Description of Related Art

A conventional encoded electronic lock has a panel exposed to the external part of the lock to allow the user to input the correct password for unlocking. For another kind of locks, a RF induction card is used to induce the lock for unlocking.

For both of the above locks, it is easy for those with bad intention to decode the password for the panel or use the lost induction card to unlock the lock, leaving that kinds of electronic locks useless.

The inventors have made long-term efforts in solving such a problem, and successfully got an approach to achieve a novel touch lock which can overcome the problem encountered in the prior art.

### SUMMARY OF THE INVENTION

A main purpose of this invention is to provide a multi-protection touch panel in which the lock can be located at the predetermined position to control the door access, vehicle actuation and the use of electrical appliances. When unlocking, the unlocking panel comes to in contact with the lock and the correct password is input via the unlocking panel. After the unlocking action is completed, the unlocking panel is removed from the predetermined position. Thereby the improved antitheft effect is achieved.

In order to achieve the above and other objectives, the multi-protection touch panel of the invention includes a lock body and an unlocking panel connecting to the lock body. The lock body has a control mechanism, a locking unit connecting to the control mechanism, at least one displaying unit connecting to the control unit, and at least one connection interface connecting to the displaying unit. The at least one unlocking panel has at least one transmission interface connecting to the at least one connection interface, and at least one operating unit connecting to the at least one transmission interface.

In one embodiment of the invention, the control mechanism has a processing unit, a power unit and a memory unit connecting one another.

In one embodiment of the invention, the power unit can be a lithium battery, a mercury battery, a solar cell, a rechargeable battery, or domestic power supply.

In one embodiment of the invention, between the control mechanism and the locking unit is a transmission unit which performs its transmission function in a wireless or wired way.

In one embodiment of the invention, between the control mechanism and the at least one displaying unit is a transmission unit which performs its transmission in wireless or wired way.

In one embodiment of the invention, the locking unit is at least a mechanical lock, an electromagnetic lock, electronically controlled lock or an optical lock.

In one embodiment of the invention, the at least one unlocking panel is made of metallic material, non-metallic material, glass or plastics.

In one embodiment of the invention, the connection interface can be a connection socket, and the at least one transmission can be a connector connecting to the connection socket.

In one embodiment of the invention, the connection interface can be an induction coil, and the transmission interface can be one RF antenna triggered by the induction coil.

In one embodiment of the invention, the at least one displaying unit and the at least one operating unit are separately mounted, and integrated as a touch panel.

In one embodiment of the invention, the at least one operating unit is a set of buttons.

### BRIEF DESCRIPTION OF THE DRAWINGS

FIG. 1 is a schematic view of a multi-protection touch lock according to a first embodiment of the invention.

FIG. 2 is a schematic, exploded view of a multi-protection touch lock according to a first embodiment of the invention.

FIG. 3 is a block diagram of a multi-protection touch lock according to a first embodiment of the invention.

FIG. 4 is a schematic view of an appearance of a multi-protection touch panel according to a second embodiment of the invention.

FIG. 5 is a schematic view of appearance of a multi-protection touch lock according to a third embodiment of the invention.

FIG. 6 is a schematic view of an appearance of a multi-protection touch lock according to a fourth embodiment of the invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

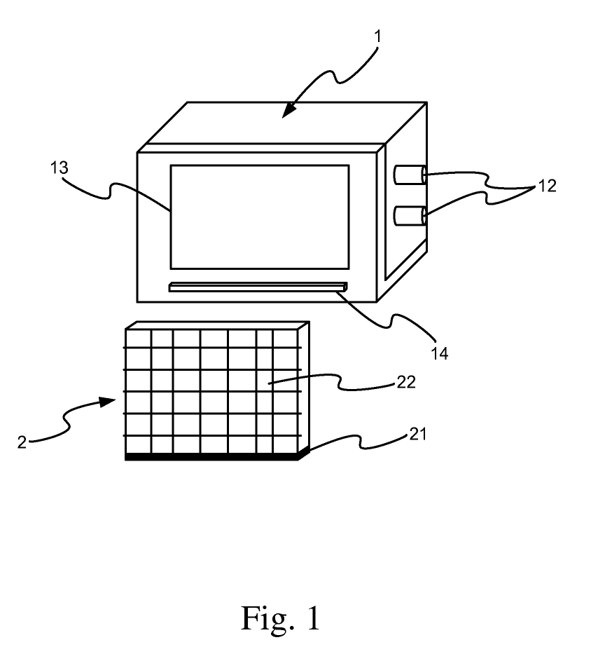

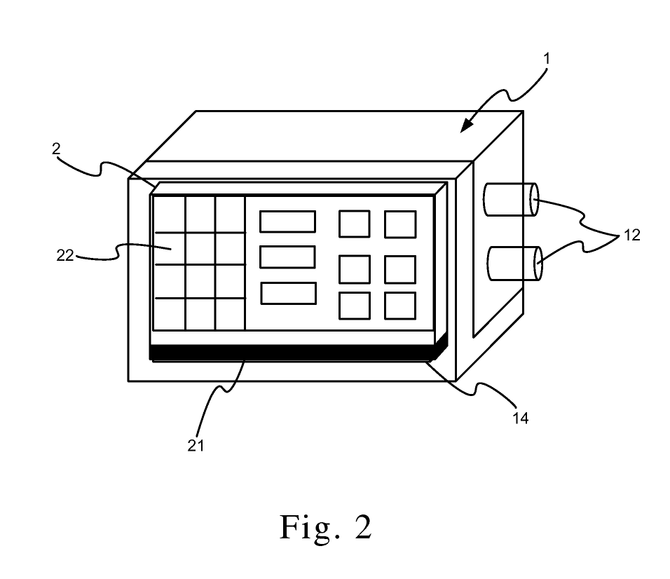

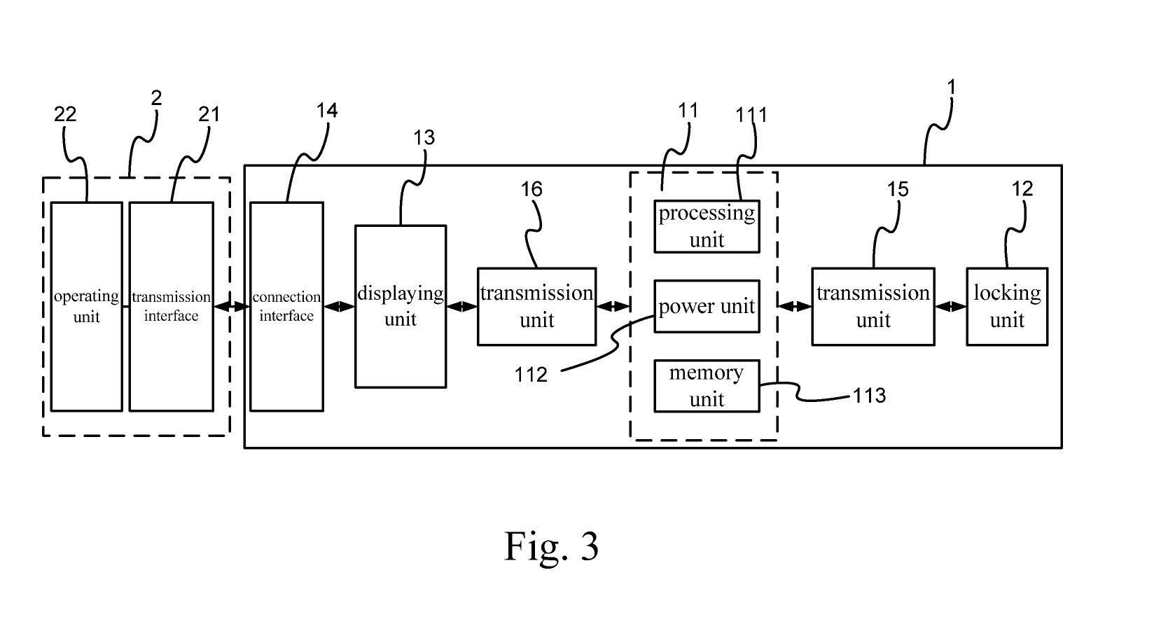

FIG. 1 is a schematic view of a multi-protection touch lock according to a first embodiment of the invention. FIG. 2 is a schematic, exploded view of a multi-protection touch lock according to a first embodiment of the invention. FIG. 3 is a block diagram of a multi-protection touch lock according to a first embodiment of the invention. As shown, the multi-protection touch lock of the invention at least includes a lock body 1 and at least one unlocking panel 2.

The above lock body 1 includes a control mechanism 11, a locking unit 12 connecting to the control mechanism 11, at least one displaying unit 13 connecting to the control mechanism 11, and at least one connection interface 14 connecting to the at least one displaying unit 13. The connection interface 14 can be a connection socket. The control mechanism 11 has a processing unit 111, a power unit 112 and a memory unit 113 connecting one another. The power unit 112 can be a lithium battery, a mercury battery, a solar cell, a rechargeable battery, or domestic power supply. Between the control mechanism 11 and the locking unit 12 is a transmission unit 15. The transmission unit 15 performs its transmission function in a wireless or wired way. Between the control mechanism 11 and the at least one displaying unit 13 is a transmission unit 16 which performs its transmission in wireless or wired way. The locking unit 12 can be at least a mechanical lock, an electromagnetic lock, electronically controlled lock or an optical lock.

The at least one unlocking panel 2 connects to the lock body 1, and can be made of metallic material, non-metallic material, glass or plastics. The at least one unlocking panel 2 contains at least one transmission interface 21 connecting to the at least one connection interface 14, and at least one operating unit 22 connecting to the at least one transmission interface 21. The at least one transmission interface 21 can be a connector connecting to the connection socket. The at least one operating unit 22 can be a touch panel or a set of buttons. Thereby, the above configuration constitutes a novel multi-protection touch lock.

When the touch lock of the present invention is in use, the lock body 1 is placed at predetermined position to control the door access, transport actuation and the use of electrical appliances. When unlocking, the transmission interface 21 of the unlocking panel 2 and the connection interface 14 of the displaying unit 13 on the lock body 1 are connecting to each other. At this moment, the power unit 112 provides the operating electricity, and meanwhile the transmission units 15, 16 respectively transmit signals to the locking unit 12 and the displaying unit 13 for the user to operate via the operating unit 22 of the unlocking panel. After a password is input, the processing unit 111 of the control mechanism 11 reads the password in the memory unit 113. If the password is correct, then the locking unit 12 is driven to unlock for access permission, transport vehicle actuation and the use of electrical appliances. The feature of detachable configuration of the unlocking panel 2 and the lock body 1 makes it necessary to connect the unlocking panel 2 to the lock body 1 and then enter the correct password to unlock. Other control functions work only after the unlocking action succeeds. Therefore, it is not easy for people with bad intention to encode. Even though the unlocking panel 2 is lost, no concern regarding security would rise because the correct password must be input for unlocking. So touch lock of this invention can achieve an improved anti-theft effect.

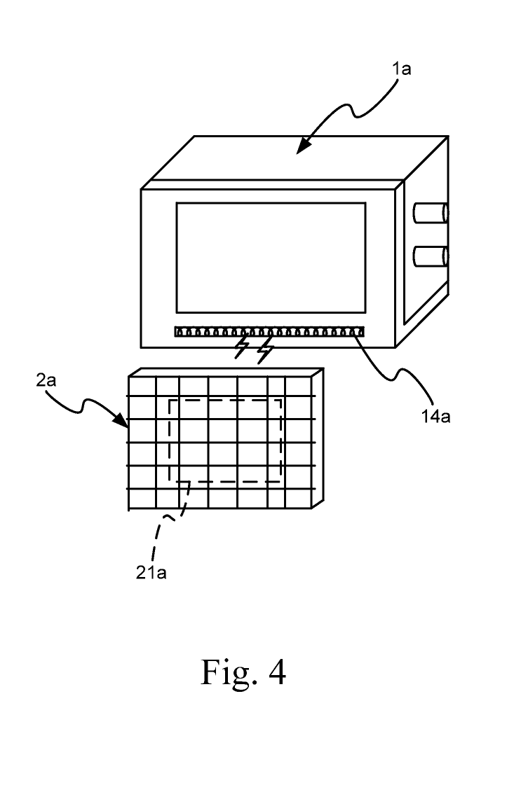

FIG. 4 is a schematic view of an appearance of a multi-protection touch panel according to a second embodiment of the invention. As shown, in the second embodiment of the invention, the multi-protection touch panel is the same as the first embodiment, except that the connection interface 14a of the lock body la can be an induction coil. The transmission interface 21a of the at least one unlocking panel 2a can be one RF antenna triggered by the induction coil. It can achieve the same efficacy of the above-mentioned first embodiment of this invention, and also meet the needs in practical use.

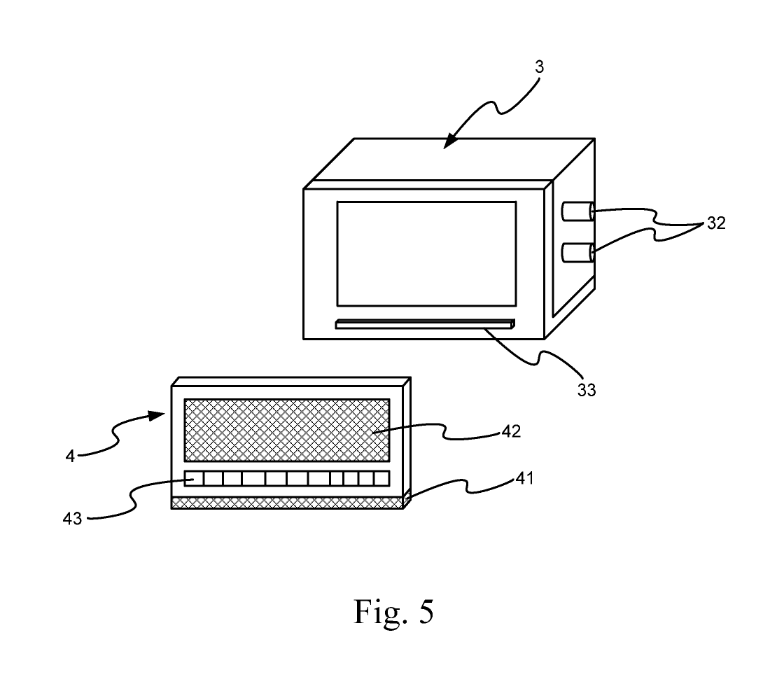

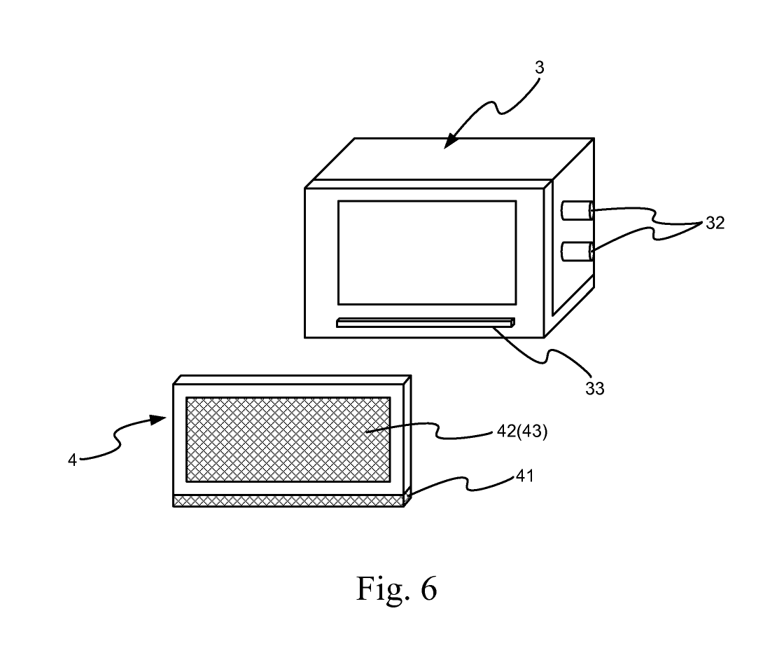

FIG. 5 is a schematic view of appearance of a multi-protection touch lock according to a third embodiment of the invention. FIG. 6 is a schematic view of an appearance of a multi-protection touch lock according to a fourth embodiment of the invention. As shown, the configurations in the third and fourth embodiments are also in the scope of the invention in addition to those in the first and second embodiments. The lock body 3 and the unlocking panel 4 are the same as the first embodiment, except that the lock body 3 includes a control mechanism 31, a locking unit 32 connecting to the control mechanism 31, and at least one connection interface 33 connecting to the control mechanism 31. The at least one unlocking panel 4 connects to the lock body 1, and contains at least one transmission interface 41 connecting to the at least one connection interface 33, at least one displaying unit 42 connecting to the at least one transmission interface 41, and at least one operating unit 43 connecting to the at least one displaying unit 42.

The at least one displaying unit 42 and the at least one operating unit 43 can be separately mounted (as shown in FIG. 5), and can be integrated as a touch panel (shown in FIG. 6) as well. The third embodiment of this invention can achieve the same effect as the first and second embodiments, and further meets the needs in the practical use by means of the at least one displaying unit 42 connecting to the at least one unlocking panel 4.

In summary, the multi-protection touch lock of the present invention can effectively improve the shortcomings of the prior art. The lock can be located at the predetermined position to control the door access, vehicle actuation and electrical appliances. When unlocking, the unlocking panel comes to in contact with the lock and the correct password is input via the unlocking panel. After the unlocking action is completed, the unlocking panel is removed from the predetermined position. Thereby the improved antitheft effect is achieved. This makes the invention more progressive and more practical in use which complies with the patent law.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A multi-protection touch lock comprising:
a lock body; comprising a control mechanism, a locking unit connecting to the control mechanism and at least one connection interface;
at least one unlocking panel, connecting to the lock body, and having at least one transmission interface connecting to the at least one connection interface, and at least one operating unit connecting to the at least one transmission interface; and
at least one displaying unit, connecting the control mechanism of the lock body or connecting to the at least one transmission interface of the unlocking panel.

2. The multi-protection touch lock of claim 1, wherein the control mechanism has a processing unit, a power unit and a memory unit connecting one another.

3. The multi-protection touch lock of claim 2, wherein the power unit can be a lithium battery, a mercury battery, a solar cell, a rechargeable battery, or domestic power supply.

4. The multi-protection touch lock of claim 1, wherein between the control mechanism and the locking unit is a transmission unit which performs its transmission function in a wireless or wired way.

5. The multi-protection touch lock of claim 1, wherein between the control mechanism and the at least one displaying unit is a transmission unit which performs its transmission in wireless or wired way.

6. The multi-protection touch lock of claim 1, wherein the locking unit is at least a mechanical lock, an electromagnetic lock, electronically controlled lock or an optical lock.

7. The multi-protection touch lock of claim 1, wherein the at least one displaying unit connects to a power unit, a memory unit and a processing unit.

8. The multi-protection touch lock of claim 1, wherein the at least one unlocking panel is made of metallic material, non-metallic material, glass or plastics.

9. The multi-protection touch lock of claim 1, wherein the connection interface can be a connection socket, and the at least one transmission can be a connector connecting to the connection socket.

10. The multi-protection touch lock of claim 1, wherein the connection interface can be an induction coil, and the transmission interface can be one RF antenna triggered by the induction coil.
